(19) United States
(12) Patent Application Publication
(10) Pub. No.: US 2011/0194610 A1
(43) Pub. Date: Aug. 11, 2011

(54) Motion-Vector Estimation

(75) Inventor: Sanbao Xu, Lund (SE)

(73) Assignee: Telefonaktiebolaget L M Ericsson (publ), Stockholm (SE)

(21) Appl. No.: 13/024,354

(22) Filed: Feb. 10, 2011

Related U.S. Application Data
(60) Provisional application No. 61/308,227, filed on Feb. 25, 2010.

(30) Foreign Application Priority Data
Feb. 10, 2010 (EP) 10153225.7

(51) Int. Cl. H04N 7/12

(52) U.S. Cl. 375/240.16; 375/E07.104; 375/E07.105; 375/E07.115; 375/E07.243

(57) ABSTRACT

A method of generating a motion vector with sub-pixel resolution associated with a first portion of a first image frame in a sequence of image frames for encoding the sequence of image frames is disclosed. An error surface represents a difference between image data of the first portion of the first image frame and image data of a second portion of a second image frame, displaced with a displacement vector in relation to the first portion, and is a function of the displacement vector. The motion vector is an estimate of a displacement vector that minimizes the value of the error surface. The method includes obtaining a coarse motion vector, which is an estimate of the motion vector with integer-pixel resolution, approximating the error surface in a neighborhood of the coarse motion vector with a biquartic polynomial, and representing terms of the biquartic polynomial with orthogonal polynomials. Moreover, the method includes generating the motion vector by searching for a displacement vector that minimizes the biquartic polynomial. A corresponding electronic apparatus, a corresponding computer program product, and a corresponding computer-readable medium are also disclosed.

### TECHNICAL FIELD

The present invention relates to motion-vector estimation with sub-pixel resolution for encoding a sequence of image frames.

### BACKGROUND

Video encoding can be utilized to reduce the size (e.g. measured in bytes) of a sequence of image frames. Normally, video encoding is performed by applying a two-dimensional (2D) discrete cosine transform (DCT) on data representing a current image frame (or a portion thereof, such as a macroblock of 16 by 16 pixels). The resulting DCT-values are then quantized for reducing the size of the encoded image frame. Redundancy due to similarities between consecutive image frames may be utilized for further reducing the size by only encoding the difference between the current image frame and a reference frame. The size of the encoded image frame may be even further reduced by employing so called motion compensation. In motion compensation, an estimate is made of how much a portion (such as a macroblock of 16 by 16 pixels) of the current image frame is displaced in relation to a corresponding (“most similar”) portion of the reference frame. The data that is subject to encoding is then the difference between the portion of the current image frame and the corresponding portion of the reference frame. The displacement is represented with a so called motion vector. In order to obtain relatively high performance video encoding, motion vectors with sub-pixel resolution, such as half-pixel and/or quarter-pixel resolution, may be employed in accordance with some video-encoding standards, e.g. H.263, H.264, MPEG-2, and MPEG-4. A straightforward solution for estimating motion vectors with sub-pixel resolution is to interpolate the image data of an image frame to determine image data at positions (“sub-pixel positions”) in between integer pixel positions, such as at half-pixel and quarter-pixel positions, and estimate the motion vectors based on the interpolated image data. A problem with this is that the computational complexity associated with the interpolation is normally relatively high, e.g., since the number of sub-pixel positions, for which image data needs to be interpolated, is normally relatively large. This, in turn, may result in relatively hard requirements on the hardware that performs the video encoding, e.g., in terms of processing speed, memory bandwidth, power-consumption, etc. Hence, a reduction of the computational complexity associated with the estimation of motion vectors with sub-pixel resolution would be desirable.

A solution where interpolation of image data can be avoided is proposed in the article P. R. Hill et al., “Interpolation free subpixel accuracy motion estimation,” IEEE Transactions on Circuits and Systems for Video Technology, December 2006, vol. 16, no. 12, pp. 1519-1526 (in the following referred to as “Hill”). Instead of interpolating the image data, a parabolic function is used to estimate a cost function that represents the sum of absolute differences (SAD) between a block (macroblock or segmented macroblock) of a current frame and a reference block of the reference frame as a function of a displacement between the block of the current frame and the reference block of the reference frame.

### SUMMARY

An object of the present invention is to provide estimation of motion vectors with sub-pixel resolution without requiring interpolation of image data.

According to a first aspect, there is provided a method of generating a motion vector with sub-pixel resolution associated with a first portion of a first image frame in a sequence of image frames for encoding the sequence of image frames. An error surface represents a difference between image data of the first portion of the first image frame and image data of a second portion of a second image frame, displaced with a displacement vector in relation to the first portion, and is a function of the displacement vector. Furthermore, the motion vector is an estimate of a displacement vector that minimizes the value of the error surface. The method comprises obtaining a coarse motion vector, which is an estimate of the motion vector with integer-pixel resolution. Furthermore, the method comprises approximating the error surface in a neighborhood of the coarse motion vector with a biquartic polynomial, and representing terms of the biquartic polynomial with orthogonal polynomials. Moreover, the method comprises generating the motion vector by searching for a displacement vector that minimizes the biquartic polynomial.

The method may further comprise generating coefficients of the biquartic polynomial from known values of the error surface for the coarse motion vector and for a number of neighboring displacement vectors with integer-pixel resolution. The number of coefficients can, e.g., be 9 and the number of neighboring displacement vectors can, e.g., be 8. Generating the coefficients may comprises multiplying a vector having the known values of the error surface with a pre-generated matrix.

The orthogonal polynomials may be Chebyshev polynomials of the first kind. For example, the biquartic polynomial, denoted b(x, y), may be on the form

b(x,y)=a₀T_{4,0}(x,y)+a₁T_{0,4}(x,y)+a₂T_{3,1}(x,y)+a₃T_{1,3}(x,y)+a₄T_{2,2}(x,y)+a₅T_{2,1}(x,y)+a₆T_{1,2}(x,y)+a₇T_{3,0}(x,y)+a₈T_{0,3}(x,y)

in which aⱼ denotes the coefficients of the biquartic polynomial, x and y are the component-wise differences between the displacement vector and the coarse motion vector in a first and a second direction, respectively, and T_{n,m}(x, y)=Tₙ(x)Tₘ(y), where Tₙ(x) and Tₘ(y) denote one-dimensional Chebyshev polynomials of the first kind of order n and m, respectively.

Alternatively, the orthogonal polynomials can, e.g., be Legendre polynomials, Laguerre polynomials, Hermite polynomials, or Chebyshev polynomials of the second kind.

Searching for the displacement vector that minimizes the biquartic polynomial may comprise executing a two-dimensional gradient descent algorithm. The two-dimensional gradient descent algorithm may employ variable step size and sub-pixel resolution.

Alternatively, searching for the displacement vector that minimizes the biquartic polynomial may comprise executing a Newton algorithm or a conjugate gradient algorithm.

According to a second aspect, there is provided an electronic apparatus for encoding a sequence of image frames. The electronic apparatus comprises a control unit adapted to perform the method according to the first aspect. The electronic apparatus may further comprise an image sensor for generating the sequence of image frames. The electronic apparatus can, e.g., be, but is not limited to, a mobile phone, a digital camera, a web camera, a video camera, or a camcorder.

According to a third aspect, there is provided a computer program product comprising computer program code means for executing the method according to the first aspect when the computer program code means are run by a programmable control unit.

According to a fourth aspect, there is provided a computer readable medium having stored thereon a computer program product comprising computer program code means for executing the method according to the first aspect when the computer program code means are run by a programmable control unit.

Further embodiments of the invention are defined in the dependent claims.

It should be emphasized that the term “comprises/comprising” when used in this specification is taken to specify the presence of stated features, integers, steps, or components, but does not preclude the presence or addition of one or more other features, integers, steps, components, or groups thereof.

### BRIEF DESCRIPTION OF THE DRAWINGS

Further objects, features and advantages of embodiments of the invention will appear from the following detailed description, reference being made to the accompanying drawings, in which:

FIG. 1 schematically illustrates a first and a second image frame and displacement vectors between a portion of the first image frame and portions of the second image frame;

FIG. 2 schematically illustrates a coordinate system with integer-pixel and half-pixel coordinates;

FIGS. 3-4 are flowcharts for methods according to embodiments of the present invention;

FIG. 5 is a simplified block diagram of an electronic apparatus according to an embodiment of the present invention; and

FIG. 6 schematically illustrates a computer-readable medium and a programmable control unit according to an embodiment of the present invention.

### DETAILED DESCRIPTION

FIG. 1 schematically illustrates a first image frame 5 and a second image frame 15. In embodiments and examples described below, the first image frame 5 is a current image frame to be encoded. Typically, image frames are divided into portions, each comprising a number of pixels, wherein the portions are encoded individually. Such a portion may, e.g., be a macroblock of, e.g., 16×16 pixels, but the invention is not limited thereto. A first such portion 10 of the first image frame 5 is indicated in FIG. 1. Furthermore, the second image frame 15 is a reference image frame that can be utilized for efficient compression when encoding the first image frame. For example, when encoding the first portion 10 (or any other portion) of the first image frame 5, the data that is actually encoded may be the difference between the image data (e.g., RGB (Red Green Blue) data or luminance and chrominance data) of the first portion 10 and corresponding image data of a corresponding reference portion of the second image frame 15. The reference portion should, qualitatively speaking, be selected such that the difference in image data between the first portion 10 of the first image frame and reference portion is as small as possible.

FIG. 1 also schematically illustrates a number of portions 20a-c of the second image frame 15. All of the portions 20a-c could be candidates for selections as the reference portion. Furthermore, FIG. 1 illustrates displacement vectors 25a-c between (the location of) the first portion 10 in the first image frame 5 and (the locations of) the portions 20a-c of the second image frame 15. The displacement vector between the first portion 10 and the portion of the second image frame 15 that is selected as the reference portion is referred to as the motion vector. The problem of selecting an appropriate reference portion of the second image frame is equivalent to the problem of determining an appropriate motion vector.

Quantitatively, the difference between the image data of the first portion 10 of the first image frame 5 and any portion of the second image frame 15 may be measured by any suitable metric. Normally, the sum of absolute differences (SAD) is used as a metric, but other metrics, such as but not limited to the sum of squared differences, may be used as well. The basic principles of video encoding and motion vectors are well known in the art and are not further described in any detail herein.

The metric used for measuring the difference defines an error surface, which is a function of the displacement vector. The value of the error surface for a given displacement vector may be equal to the metric of the difference between the image data of the first portion 10 of the first image frame and the image data of a second portion of the second image frame 15, which is displaced with the displacement vector in relation to the first portion 10. More generally speaking, the error surface represents a difference between image data of the first portion 10 of the first image frame 5 and the image data of a second portion of a second image frame 15, displaced with the displacement vector in relation to the first portion 10. The error surface is sometimes referred to as the residue of prediction.

Ideally, the motion vector is determined as the displacement vector that minimizes the error surface. However, e.g., due to a limited resolution in the representation of the displacement vectors, it is in general not possible to find the displacement vector that exactly minimizes the error surface. Instead, the motion vector is an estimate of a displacement vector that minimizes the error surface.

Since the image data of the first image frame 5 and the second image frame 15 is known at integer pixel positions, the values of the error surface for displacement vectors with integer-pixel resolution can be calculated in a straightforward manner. However, when seeking to determine motion vectors with sub-pixel resolution, this is not sufficient; also values of the error surface for at least some displacement vectors with sub-pixel resolution are needed. As indicated in the background section, this has traditionally been accomplished by interpolating the image data of the image frames to determine image data at sub-pixel positions, e.g., half-pixel and quarter-pixel positions, from which values of the error surface can be determined for displacement vectors with sub-pixel resolution. As is also indicated in the background section, it was suggested in Hill to approximate the SAD, which is an example of an error surface, with a parabolic (or biquadratic) function in order to avoid the need for interpolation of image data. However, in accordance with embodiments of the present invention, the inventor has realized that the biquadratic approximation of the error surface has a too low polynomial order to be able to represent the error surface, which for many video sequences may be relatively complex, accurately enough for successful determination of motion vectors with sub-pixel resolution. In fact, the inventor has realized that the accuracy may in many cases be insufficient even if the polynomial order is increased to a bicubic approximation. The inventor has deduced that a biquartic approximation of the error surface is better suited than a biquadratic or bicubic approximation for the purpose of determining a motion vector with sub-pixel resolution. A general biquartic polynomial B(x, y) in the variables x and y is given by:

B(x,y)=Σⱼ₌₀⁴Σₖ₌₀^{4-j}c_{j,k}x^{j}y^{k} (Eq. 1)

where c_{j,k} are free (i.e., independent) coefficients of the general biquartic polynomial.

According to embodiments of the present invention, there is provided a method of generating a motion vector with sub-pixel resolution associated with the first portion 10 of the first image frame 5 for encoding the sequence of image frames. Note that the first image frame 5 can be any image frame of a sequence of image frames. Hence, the method is not limited to a particular image frame, but may be applied to any image frame(s) of the sequence. Furthermore, note that the first portion 10 can be any portion of the first image frame 5. Hence, the method is not limited to a particular portion, but may be applied to any portion(s) of any image frame.

The method comprises obtaining a coarse motion vector. The coarse motion vector is an estimate, with integer-pixel resolution, of the motion vector. The coarse motion vector can, e.g., have been generated using any known (or future) method of determining a motion vector with integer-pixel resolution. According to some embodiments, obtaining the coarse motion vector includes generating the coarse motion vector. According to other embodiments, the coarse motion vector may have been generated outside the method, e.g., in another process. Obtaining the coarse motion vector may include obtaining the coarse motion vector from that other process. The coarse motion vector can, e.g., be the one of the displacement vectors with integer-pixel resolution that results in the smallest value of the error surface. A search for a suitable displacement vector with sub-pixel resolution that can be used as the motion vector can then be performed in a neighborhood of the coarse motion vector, as described in more detail below. For that purpose, the error surface is, in accordance with embodiments of the method, approximated with a biquartic polynomial in the neighborhood of the coarse motion vector.

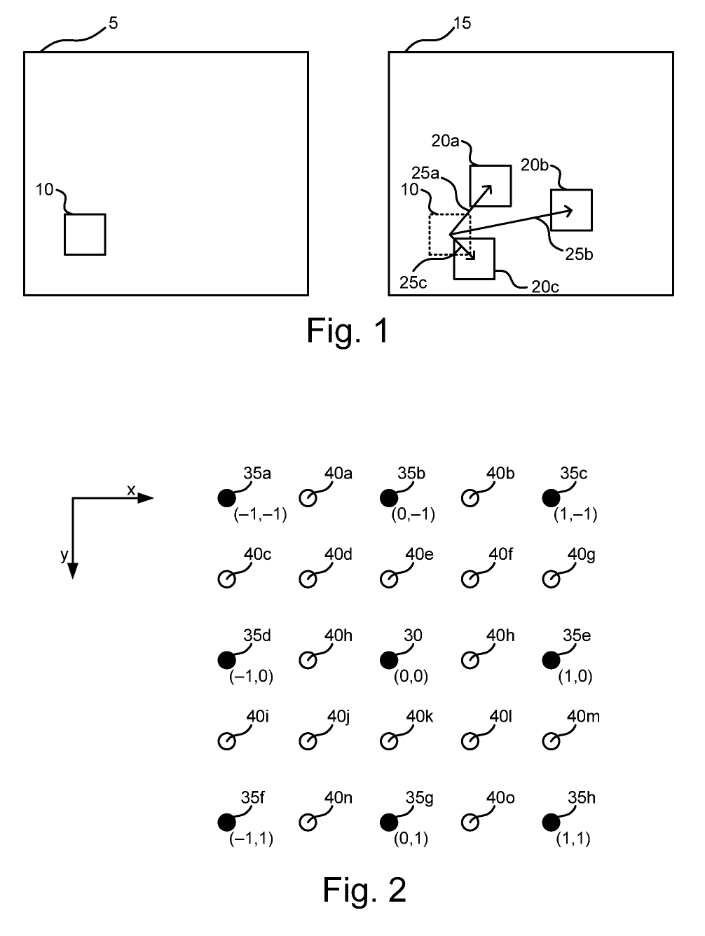

FIG. 2 schematically illustrates a coordinate system that is used for the biquartic polynomial in embodiments and examples in the following. Axes for an x direction and a y direction are also indicated in FIG. 2. The “unit” for both the x axis and the y axis is “pixels”. A number of points 30 and 35a-h are marked with solid dots. Coordinates for these points 30, 35a-h are also indicated on the form (x, y). These points 30, 35a-h represent displacement vectors with integer-pixel resolution. The point 30 with the coordinate (0,0) represents the coarse motion vector. The points 35a-h represent the 8 closest neighbors of the coarse motion vector. Hence, the x and y coordinates of a point in FIG. 2 represents the differences in the x and y directions, respectively, between the displacement vector represented with that point and the coarse motion vector. In embodiments and examples presented below, it is these x and y coordinates that are used as arguments, or variables, in the biquartic polynomial. In addition, displacement vectors with half-pixel resolution (i.e. where the each component of the displacement vector is represented with half-pixel resolution) are represented with points 40a-o marked with circles. Each displacement vector corresponds to a unique point in the coordinate system of FIG. 2, and determining a displacement vector that should be used as the motion vector is equivalent to finding the corresponding point in the coordinate system of FIG. 2. For simplicity, only points representing motion vectors with integer-pixel resolution and half-pixel resolution are indicated in FIG. 2. However, embodiments of the present invention are applicable to other resolutions as well, e.g., quarter-pixel resolution (which can, e.g., be employed in H.264 and MPEG-4 video codecs) or even finer resolutions.

A problem with the general biquartic polynomial given by Eq. 1 is that it has 15 free coefficients c_{j,k}, which in this context is a relatively large number. For example, at least 15 values of the error surface need to bee known in order to determine these 15 coefficients. Hence, in order to determine the 15 coefficients, the values of the error surface need to be evaluated for 15 different displacement vectors with integer-pixel resolution in and/or in proximity of the neighborhood of where the search for the motion vector is to be performed. Values of the error surface for a number of such relevant displacement vectors with integer-pixel resolution may already have been calculated in the process of determining the coarse motion vector. These values can be reused, thereby achieving computational efficiency of the method. However, the number of relevant displacement vectors for which the error surface has already been calculated in the process of determining the coarse motion vector is rarely as many as 15. Hence, additional evaluations of the error surface for a number of displacement vectors with integer-pixel resolution would normally be needed to determine all coefficients if a general biquartic polynomial were to be used, which would add to the computational cost of the method. The inventor has thus realized that it would be desirable to reduce the number of coefficients of the biquartic polynomial that need to be determined. According to embodiments of the method, terms of the biquartic polynomials are therefore represented with orthogonal polynomials, whereby the number of coefficients can be reduced as is exemplified below. In examples and embodiments described below, the orthogonal polynomials are Chebyshev polynomials of the first kind. However, other types of orthogonal polynomials may be used as well, such as but not limited to Legendre polynomials, Laguerre polynomials, Hermite polynomials, or Chebyshev polynomials of the second kind.

Furthermore, embodiments of the method comprise generating the motion vector by searching for a displacement vector that minimizes the biquartic polynomial that is used to approximate the error surface. Note that, in general, it may be practically impossible to find the displacement vector that exactly minimizes the biquartic polynomial. This is, e.g., due to that the numerical resolution of the displacement vectors used during the search is limited (even if sub-pixel resolution is used). Hence, the motion vector need not necessarily be the displacement vector that exactly minimizes the biquartic polynomial, but should be a good (e.g., the best) one of those found during the search for the minimum. Suitable search algorithms are discussed below.

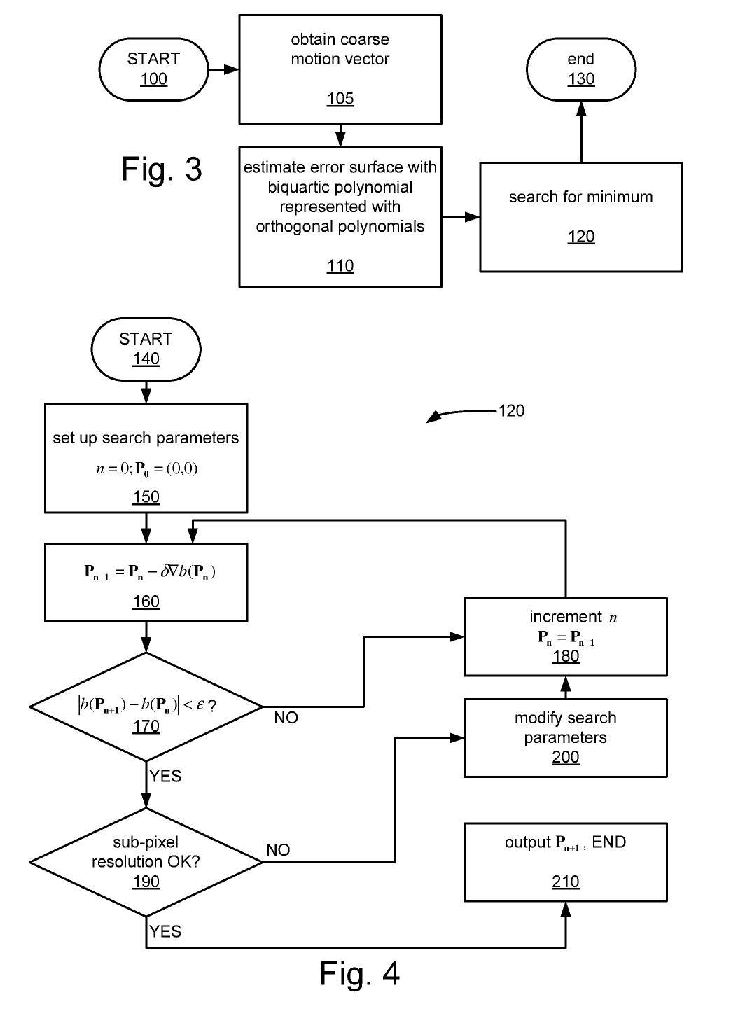

FIG. 3 is a flowchart of an embodiment of the method. The operation of the method is started in step 100. In step 105, the coarse motion vector is obtained. In step 110, the error surface is approximated in a neighborhood of the coarse motion vector with a biquartic polynomial, terms of which are represented with orthogonal polynomials. Step 110 can, e.g., comprise determining coefficients of the biquartic polynomial. In step 120, the motion vector is generated by searching for a displacement vector that minimizes the biquartic polynomial.

Some embodiments of the method comprises (e.g. in step 110, FIG. 3) generating coefficients of the biquartic polynomial from values of the error surface for the coarse motion vector and for a number of neighboring displacement vectors with integer-pixel resolution. As mentioned above, the number of relevant (i.e. relevant for determination of coefficients of the biquartic polynomial) displacement vectors with integer-pixel resolution for which the values of the error surface have already been calculated is rarely as many as 15. However, for many known algorithms of determining a motion vector with integer-pixel precision that are suitable for determining the coarse motion vector, it can be expected that the error surface has been evaluated at least for the coarse motion vector and its eight nearest neighbors, i.e. for the displacement vectors represented with the points 30 (coarse motion vector) and 35a-h (eight nearest neighbors). Therefore, according to some embodiments of the method, the coefficients of the biquartic polynomial are generated based on the values of the error surface for the coarse motion vector and its 8 neighboring displacement vectors with integer-pixel resolution. The use of a total of 9 known values of the error surface allows for the generation of coefficients of a biquartic polynomial with up to 9 free coefficients. According to an embodiment, which is used as an example throughout the rest of this specification, the biquartic polynomial, denoted b(x, y), is on the form:

b(x,y)=a₀T_{4,0}(x,y)+a₁T_{0,4}(x,y)+a₂T_{3,1}(x,y)+a₃T_{1,3}(x,y)+a₄T_{2,2}(x,y)+a₅T_{2,1}(x,y)+a₆T_{1,2}(x,y)+a₇T_{3,0}(x,y)+a₈T_{0,3}(x,y) (Eq. 2)

wherein aⱼ, j=0, 1, . . . , 8, denotes the 9 free coefficients of the biquartic polynomial. The variables x and y are the component-wise differences between the displacement vector and the coarse motion vector in a first and a second direction, respectively, as described with reference to FIG. 2 above. The expressions T_{n,m}(x, y) denote two-dimensional Chebyshev polynomials of the first kind determined by

T_{n,m}(x,y)=Tₙ(x)Tₘ(y) (Eq. 3)

wherein Tₙ(x) and Tₘ(y) denote one-dimensional Chebyshev polynomials of the first kind of order n and m, respectively. Such a one-dimensional polynomial of the first kind is given by

Tₙ(x)=cos(n arccos(x)) (Eq. 4)

The biquartic polynomial b(x, y) given by Eq. 2 can be rewritten on the same form as the general biquartic polynomial B(x, y) given by Eq. 1, i.e., with 15 terms on the form c_{j,k}x^{j}y^{k}. A difference from the general biquartic polynomial B(x, y) is that, in this case, only 9 of the coefficients are free, whereas the other 6 are dependent on the 9 free coefficients. Hence, some degrees of freedom are lost compared with a general biquartic polynomial. However, since the biquartic polynomial given by Eq. 2 involves all combinations of x^{j}y^{k} present in the general biquartic polynomial B(x, y) of Eq. 1, it is still in a better position to accurately approximate the error surface than a biquadratic or bicubic polynomial.

The values of the biquartic polynomial b(x, y) for the points 30 and 35a-h (FIG. 2) can be expressed on a matrix form given by

$$[ \begin{matrix}b ( - 1 , 1 ) \\ b ( - 1 , 0 ) \\ b ( - 1 , 1 ) \\ b ( 0 , - 1 ) \\ b ( 0 , 0 ) \\ b ( 0 , 1 ) \\ b ( 1 , - 1 ) \\ b ( 1 , 0 ) \\ b ( 1 , 1 )\end{matrix} ] = A [ \begin{matrix}{a}_{0} \\ {a}_{1} \\ {a}_{2} \\ {a}_{3} \\ {a}_{4} \\ {a}_{5} \\ {a}_{6} \\ {a}_{6} \\ {a}_{8}\end{matrix} ] \qquad ( Eq . 5 )$$

where A is a 9×9 matrix, the components of which are given by Eq. 2. Setting a condition that b(x, y) should be equal to the error surface (in the following denoted e(x, y)) that it approximates for the points 30 and 35a-h (FIG. 2), the coefficients a₀-a₈ can be determined from

$$[ \begin{matrix}{a}_{0} \\ {a}_{1} \\ {a}_{2} \\ {a}_{3} \\ {a}_{4} \\ {a}_{5} \\ {a}_{6} \\ {a}_{7} \\ {a}_{8}\end{matrix} ] = {A}^{- 1} [ \begin{matrix}e ( - 1 , 1 ) \\ e ( - 1 , 0 ) \\ e ( - 1 , 1 ) \\ e ( 0 , - 1 ) \\ e ( 0 , 0 ) \\ e ( 0 , 1 ) \\ e ( 1 , - 1 ) \\ e ( 1 , 0 ) \\ e ( 1 , 1 )\end{matrix} ] \qquad ( Eq . 6 )$$

The elements of A, and consequently those of its inverse A⁻¹, are constant and given by the values of the expressions T_{n,m}(x, y) in Eq. 8 for the points 30 and 35a-h (FIG. 2). These values are constants, and therefore A⁻¹ can be pre-generated. Hence, no matrix generation or inversion “on the fly” for generating A⁻¹ is required for determining the coefficients a₀-a₈, which is an advantage for keeping the computational cost of the method relatively low. In embodiments using other numbers of coefficients than 9 and/or other types of orthogonal polynomials than Chebyshev polynomials of the first kind, the coefficients of the biquartic polynomial can also be determined by multiplying a vector with known values of the error surface e(x, y) with a pre-generated matrix in a similar way (but with a different pre-generated matrix). Hence, in accordance with embodiments of the method, generating the coefficients of the biquartic polynomial can comprise multiplying a vector with known values of the error surface with a pre-generated matrix.

The search for the minimum of the biquartic polynomial (e.g., step 120 in FIG. 3) for determining the motion vector with sub-pixel resolution can e.g. be performed by executing a two-dimensional gradient descent algorithm according to embodiments of the method. FIG. 4 is a flow chart of step 120 for such an embodiment. In the following, n is an iteration index, Pₙ=(xₙ, yₙ) denotes a point in the coordinate system illustrated in FIG. 2 associated with the iteration index n, δ is a step size, ∇b(Pₙ) is the gradient of the biquartic polynomial b(x, y) at the point Pₙ, and ε is a threshold. The embodiment of the two-dimensional gradient descent algorithm illustrated in FIG. 4 employs a variable step size δ and a variable sub-pixel resolution. The search may be started with a relatively coarse sub-pixel resolution (e.g., half-pixel resolution), and finer resolutions (e.g., quarter-pixel resolution, and possibly even finer depending on the desired final sub-pixel resolution) are used as the algorithm closes in on the minimum of the biquartic polynomial. At the same time as the sub-pixel resolution is changed to a finer resolution, the step size δ is also decreased. In other embodiments, a fixed sub-pixel resolution and/or a fixed step size δ can be used, e.g., corresponding to the sub-pixel resolution and/or step size δ, respectively, used in the end of the embodiment with variable sub-pixel resolution and step size δ illustrated in FIG. 4. However, using a fixed sub-pixel resolution and/or a fixed step size δ may result in a slower search, since unnecessarily fine resolution and/or unnecessarily small steps may thereby be used in the beginning of the search.

According to the embodiment illustrated in FIG. 4, the operation of step 120 is started in step 140. In step 150, the iteration index n is set to 0, the starting point Pₙ (i.e. P₀) is set to (0,0), and initial search parameters are set up. The search parameters include the step size δ, the sub-pixel resolution, and the threshold ε. In step 160, a new candidate point Pₙ₊₁=Pₙ−δ∇b(Pₙ) is generated. In step 170, it is checked whether the absolute value of the difference b(Pₙ₊₁)−b(Pₙ) is less than the threshold ε. If not, the iteration index n is incremented in step 180, and the operation returns to step 160 where a new iteration is commenced. Due to the increment of n, the point Pₙ₊₁ of the previous iteration becomes the starting point Pₙ of the new iteration. According to some embodiments, one variable is used for representing (i.e. storing the value of) Pₙ in every iteration, and another variable is used for representing Pₙ₊₁ in every iteration. In these embodiments, step 180 includes assigning the value of Pₙ₊₁ to the variable used for representing Pₙ, as indicated in FIG. 4 with the assignment operation Pₙ=Pₙ₊₁ in step 180.

On the other hand, if it is concluded in step 170 that the absolute value of the difference b(Pₙ₊₁)−b(Pₙ) is less than the threshold ε, the operation proceeds to step 190. In step 190, it is checked whether the sub-pixel resolution used in the iteration meets the sub-pixel resolution requirement (e.g., if the motion vector should be generated with quarter-pixel resolution, was quarter-pixel resolution used in the iteration?). If not, the operation proceeds to step 200, where search parameters are modified, or refined. Step 200 can comprise setting a finer sub-pixel resolution. Furthermore, step 200 can comprise decreasing the step size δ. The operation then proceeds to step 180 described above.

On the other hand, if it is concluded in step 190 that the sub-pixel resolution used in the iteration in fact meets the sub-pixel resolution requirement, the operation proceeds to step 210. In step 210, the point Pₙ₊₁ is output from the gradient-descent algorithm and the operation of step 120 is ended (the motion vector can be generated by adding the x coordinate xₙ₊₁ and the y coordinate yₙ₊₁ of the point Pₙ₊₁ to the x component and y component, respectively, of the coarse motion vector). Suitable values of the sub-pixel resolution and step-size δ for use in different stages of the search can, e.g., be empirically determined. For example, an embodiment of the method can be applied to one or more “typical” video sequences, and the values of the sub-pixel resolution and step size δ can be adjusted until an average time (or other suitable measure, such as average number of iterations) for the search is, e.g., minimized or below an acceptable level. As a rule of thumbs, the inventor has realized that a suitable value of the step size δ can be a factor 2 smaller than the sub-pixel resolution. For example, for a sub-pixel resolution of ½ (i.e., half-pixel resolution), a step size δ of ¼ can be suitable, for a sub-pixel resolution of ¼ (i.e., quarter-pixel resolution), a step size δ of ⅛ can be suitable, etc.

In accordance with some embodiments, also the threshold ε may be varied in step 200. For example, at the same time as the sub-pixel resolution is changed to a finer resolution, the threshold ε may also be decreased. Suitable values of ε for use in different stages of the search can, e.g., be empirically determined in a similar way as indicated above for the sub-pixel resolution and step size δ.

The above-mentioned gradient-descent algorithm is only an example of search algorithms that can be used when searching for the minimum of the biquartic polynomial. For example, the search for the minimum of the biquartic polynomial for determining the motion vector with sub-pixel resolution can, e.g., be performed by executing a Newton algorithm or a conjugate gradient algorithm.

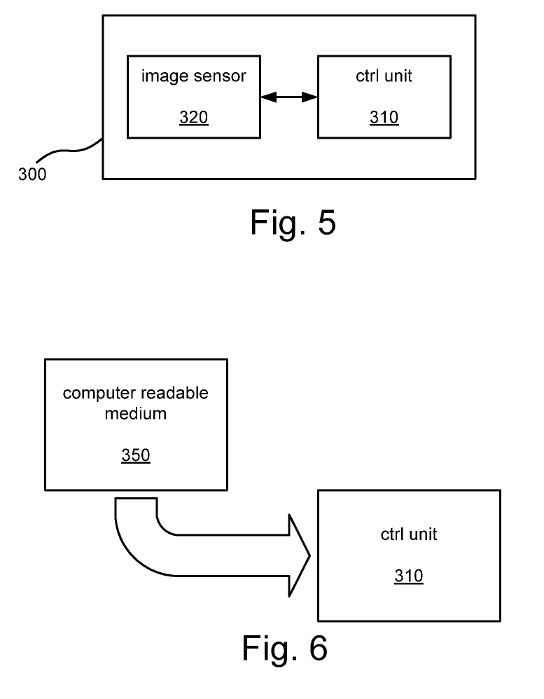

According to some embodiments of the present invention, there is provided an electronic apparatus 300 for encoding a sequence of image frames. An embodiment of the electronic apparatus 300 is schematically illustrated in FIG. 5. According to the embodiment, the electronic apparatus comprises a control unit 310 adapted to perform the method according to any of the embodiments described above.

Hence, the control unit 310 can be adapted to determine the coarse motion vector as described above with reference to embodiments of the method. Furthermore, the control unit 310 can be adapted to approximate the error surface in a neighborhood of the estimate of the coarse motion vector with a biquartic polynomial, and represent terms of the biquartic polynomial with orthogonal polynomials as described above with reference to embodiments of the method. Moreover, the control unit 310 can be adapted to generate the motion vector by searching for a displacement vector that minimizes the biquartic polynomial as described above with reference to embodiments of the method.

The control unit 310 can be adapted to generate coefficients of the biquartic polynomial from known values of the error surface for the coarse motion vector and for a number of neighboring displacement vectors with integer-pixel resolution as described above with reference to embodiments of the method. As a non-limiting example, as described above with reference to embodiments of the method, the number of coefficients can be 9 and the number of neighboring displacement vectors can be 8.

The control unit can, e.g., be adapted to generate the coefficients by multiplying a vector having the known values of the error surface with a pre-generated matrix, as described above with reference to embodiments of the method.

As described above with reference to embodiments of the method, the orthogonal polynomials utilized by the control unit 310 for representing terms of the biquartic polynomial can be Chebyshev polynomials of the first kind. For example, the biquartic polynomial can be on the form given by Eq. 2. However, other types of orthogonal polynomials, such as Legendre polynomials, Laguerre polynomials, Hermite polynomials, or Chebyshev polynomials of the second kind, can also be utilized by the control unit 310 for representing terms of the biquartic polynomial.

The control unit 310 can further be adapted to search for the displacement vector that minimizes the biquartic polynomial by executing a two-dimensional gradient descent algorithm, e.g., as described above with reference to FIG. 4. However, according to some embodiments, the control unit 310 can be adapted to search for the displacement vector that minimizes the biquartic polynomial by executing some other kind of search algorithm, such as but not limited to a Newton algorithm or a conjugate gradient algorithm.

As illustrated in FIG. 5, the electronic apparatus 300 can further comprise an image sensor 320 (or “camera”) for generating the sequence of image frames. The electronic apparatus 300 can, e.g., be, but is not limited to, any of a mobile phone, a digital camera, a web camera, a video camera, and a camcorder.

The control unit 310 (FIG. 5) can be implemented as an application-specific hardware unit. Alternatively, the control unit 310, or parts thereof, can be implemented using one or more configurable or programmable hardware units, such as but not limited to one or more field-programmable gate arrays (FPGAs), processors, or microcontrollers. Hence, the control unit 310 can be a programmable control unit 310. Embodiments of the present invention can thus be embedded in a computer program product, which enables implementation of the method and functions described herein, e.g. the embodiments of the method described above. Therefore, according to embodiments of the present invention, there is provided a computer program product, comprising instructions arranged to cause the control unit 310 to perform the steps of any of the embodiments of the method described above. The computer program product can comprise program code which is stored on a computer readable medium 350, as illustrated in FIG. 6, which can be loaded and executed by the control unit 310 to cause it to perform the steps of any of the embodiments of the method described above.

The present invention has been described above with reference to specific embodiments. However, other embodiments than the above described are possible within the scope of the invention. Different method steps than those described above, performing the method by hardware or software, may be provided within the scope of the invention. The different features and steps of the embodiments may be combined in other combinations than those described. The scope of the invention is only limited by the appended patent claims.

What is claimed is:

1. A method of generating a motion vector with sub-pixel resolution associated with a first portion of a first image frame in a sequence of image frames for encoding the sequence of image frames, the method comprising:
obtaining a coarse motion vector that is an estimate of a motion vector with integer-pixel resolution, wherein the motion vector is an estimate of a displacement vector that minimizes a value of an error surface that represents a difference between image data of the first portion of the first image frame and image data of a second portion of a second image frame displaced with the displacement vector in relation to the first portion and that is a function of the displacement vector;
approximating the error surface in a neighborhood of the coarse motion vector with a biquartic polynomial;
representing terms of the biquartic polynomial with orthogonal polynomials; and
generating the motion vector by searching for a displacement vector that minimizes the biquartic polynomial.

2. The method of claim 1, further comprising generating coefficients of the biquartic polynomial from known values of the error surface for the coarse motion vector and for a number of neighboring displacement vectors with integer-pixel resolution.

3. The method of claim 2, wherein nine coefficients of the biquartic polynomial are generated and the number of neighboring displacement vectors is eight.

4. The method of claim 2, wherein generating coefficients comprises multiplying a vector having the known values of the error surface with a pre-generated matrix.

5. The method of claim 1, wherein the orthogonal polynomials include Chebyshev polynomials of a first kind, or Legendre polynomials, Laguerre polynomials, Hermite polynomials, or Chebyshev polynomials of a second kind.

6. The method of claim 5, wherein the orthogonal polynomials are Chebyshev polynomials of the first kind and the biquartic polynomial has a form:
b(x,y)=a₀T_{4,0}(x,y)+a₁T_{0,4}(x,y)+a₂T_{3,1}(x,y)+a₃T_{1,3}(x,y)+a₄T_{2,2}(x,y)+a₅T_{2,1}(x,y)+a₆T_{1,2}(x,y)+a₇T_{3,0}(x,y)+a₈T_{0,3}(x,y)
wherein aⱼ denotes coefficients of the biquartic polynomial, x and y are component-wise differences between the displacement vector and the coarse motion vector in a first direction and a second direction, respectively, and T_{n,m}(x, y)=Tₙ(x)Tₘ(y), wherein Tₙ(x) and Tₘ(y) denote one-dimensional Chebyshev polynomials of the first kind of order n and m, respectively.

7. The method of claim 1, wherein searching for the displacement vector that minimizes the biquartic polynomial comprises executing a two-dimensional gradient descent algorithm or executing a Newton algorithm or a conjugate gradient algorithm.

8. The method of claim 7, wherein searching for the displacement vector that minimizes the biquartic polynomial comprises executing the two-dimensional gradient descent algorithm and the two-dimensional gradient descent algorithm employs variable step size and sub-pixel resolution.

9. An electronic apparatus for encoding a sequence of image frames, comprising a control unit adapted to perform the method of claim 1.

10. The electronic apparatus of claim 9, wherein the control unit is further adapted to generate coefficients of the biquartic polynomial from known values of the error surface for the coarse motion vector and for a number of neighboring displacement vectors with integer-pixel resolution.

11. The electronic apparatus of claim 9, wherein the orthogonal polynomials include Chebyshev polynomials of a first kind, or Legendre polynomials, Laguerre polynomials, Hermite polynomials, or Chebyshev polynomials of a second kind.

12. The electronic apparatus of claim 9, wherein the control unit is adapted to search for the displacement vector that minimizes the biquartic polynomial by at least executing a two-dimensional gradient descent algorithm or executing a Newton algorithm or a conjugate gradient algorithm.

13. The electronic apparatus of claim 9, further comprising an image sensor for generating the sequence of image frames.

14. The electronic apparatus of claim 9, wherein the electronic apparatus is included in a mobile phone, digital camera, web camera, video camera, or camcorder.

15. A computer-readable medium having stored thereon a non-transitory computer program that, when executed by a programmable control unit, causes the control unit to perform the method of claim 1.

16. The medium of claim 15, wherein the method further comprises generating coefficients of the biquartic polynomial from known values of the error surface for the coarse motion vector and for a number of neighboring displacement vectors with integer-pixel resolution.

17. The medium of claim 16, wherein generating coefficients comprises multiplying a vector having the known values of the error surface with a pre-generated matrix.

18. The medium of claim 15, wherein the orthogonal polynomials include Chebyshev polynomials of a first kind, or Legendre polynomials, Laguerre polynomials, Hermite polynomials, or Chebyshev polynomials of a second kind.

19. The medium of claim 15, wherein the orthogonal polynomials are Chebyshev polynomials of the first kind and the biquartic polynomial has a form:
b(x,y)=a₀T_{4,0}(x,y)+a₁T_{0,4}(x,y)+a₂T_{3,1}(x,y)+a₃T_{1,3}(x,y)+a₄T_{2,2}(x,y)+a₅T_{2,1}(x,y)+a₆T_{1,2}(x,y)+a₇T_{3,0}(x,y)+a₈T_{0,3}(x,y)
wherein aⱼ denotes coefficients of the biquartic polynomial, x and y are component-wise differences between the displacement vector and the coarse motion vector in a first direction and a second direction, respectively, and T_{n,m}(x, y)=Tₙ(x)Tₘ(y), wherein Tₙ(x) and Tₘ(y) denote one-dimensional Chebyshev polynomials of the first kind of order n and m, respectively.

20. The medium of claim 15, wherein searching for the displacement vector that minimizes the biquartic polynomial comprises executing a two-dimensional gradient descent algorithm or executing a Newton algorithm or a conjugate gradient algorithm.
